(19) United States
(12) Patent Application Publication
(10) Pub. No.: US 2026/0252234 A1
(43) Pub. Date: Aug. 27, 2026

(54) INFORMATION PROCESSING APPARATUS, CONTROL METHOD, AND NON-TRANSITORY COMPUTER-READABLE MEDIUM

(71) Applicant: Lenovo Japan LLC, Tokyo (JP)

(72) Inventors: Ryohta Nomura, Kanagawa (JP); Tran Minh Khuong Vu, Kanagawa (JP); Kyosuke Abe, Kanagawa (JP)

(73) Assignee: Lenovo Japan LLC, Tokyo (JP)

(21) Appl. No.: 19/446,082

(22) Filed: Jan. 12, 2026

(30) Foreign Application Priority Data
Feb. 25, 2025 (JP) 2025-027952

(51) Int. Cl. G06F 3/04883; G06T 11/60; G06V 30/14

(52) U.S. Cl. CPC G06F 3/04883; G06T 11/60; G06V 30/14; G06T 2200/24

(57) ABSTRACT

An information processing apparatus includes: a drawing detection unit that detects a drawing stroke corresponding to a trajectory of handwritten input in a screen region; a drawing analysis unit that analyzes drawing content of the drawing stroke detected by the drawing detection unit; and an execution control unit that causes execution of processing based on the drawing content analyzed by the drawing analysis unit and a positional relationship between the drawing stroke detected by the drawing detection unit and content displayed in the screen region other than the drawing stroke.

### CROSS-REFERENCE TO RELATED APPLICATIONS

This application claims priority to Japanese Patent Application No. 2025-027952 filed on February 25, 2025, the contents of which are hereby incorporated herein by reference in their entirety.

### BACKGROUND

### Technical Field

The present invention relates to an information processing apparatus and a control method.

### Description to Related Art

In recent years, there are search functions that allow users to search for a part of interest in an image or illustration displayed on a screen by circling the part with a stylus or the like (see, for example, “Find Information about Photos and Text with Google’s New ‘Circle to Search’ Feature,” [online], July 16, 2024, Android Magazine, [searched November 1, 2024], Internet <URL: https://www.android.com/intl/ja_jp/articles/416/>). Such functions can be regarded as effectively utilizing the advantage of a stylus, which allows users to freely select anywhere on the screen.

Although it is convenient for users to be able to search for content displayed in a part of the screen simply by operating with a stylus or the like as mentioned above, it is desirable that such operations can be utilized not only for search functions but also for a wider range of other functions.

### SUMMARY

The present invention has been made in view of the foregoing circumstances, and has an objective of providing an information processing apparatus and a control method capable of more effectively utilizing operations performed on a screen.

To solve the problem stated above, an information processing apparatus according to a first aspect of the present invention includes: a drawing detection unit configured to detect a drawing stroke corresponding to a trajectory of handwritten input in a screen region; a drawing analysis unit configured to analyze drawing content of the drawing stroke detected by the drawing detection unit; and an execution control unit configured to cause execution of processing based on the drawing content analyzed by the drawing analysis unit and a positional relationship between the drawing stroke detected by the drawing detection unit and content displayed in the screen region other than the drawing stroke.

In the information processing apparatus, the execution control unit may cause execution of processing based on the drawing content analyzed by the drawing analysis unit, on content that is displayed in the screen region and overlaps the drawing stroke detected by the drawing detection unit.

In the information processing apparatus, in a case where the drawing stroke detected by the drawing detection unit overlaps a region of a character string displayed in the screen region, the execution control unit may cause execution of the processing based on the drawing content analyzed by the drawing analysis unit, on the character string.

In the information processing apparatus, in a case where the drawing stroke detected by the drawing detection unit overlaps a region of a window of an application displayed in the screen region, the execution control unit may cause execution of processing of a function corresponding to the drawing content analyzed by the drawing analysis unit, among functions of the application.

In the information processing apparatus, in a case where the drawing stroke detected by the drawing detection unit overlaps a region of an image displayed in the screen region, the execution control unit may cause execution of image processing based on the drawing content analyzed by the drawing analysis unit, on the image.

In the information processing apparatus, the drawing analysis unit may analyze the drawing stroke detected by the drawing detection unit and extract, as the drawing content, a drawing stroke indicating a character and a drawing stroke indicating a range, and the execution control unit may cause execution of processing based on the drawing stroke indicating the character, on content that is displayed in the screen region and overlaps the drawing stroke indicating the range.

In the information processing apparatus, in a case where the drawing stroke detected by the drawing detection unit overlaps a blank region in the screen region, the execution control unit may cause execution of preset processing.

In the information processing apparatus, the execution control unit may cause execution of processing based on the drawing content analyzed by the drawing analysis unit, on content that is displayed in the screen region and is adjacent to the drawing stroke detected by the drawing detection unit.

In the information processing apparatus, in a case where the drawing stroke detected by the drawing detection unit includes a formula and is adjacent to a region of a number displayed in the screen region, the execution control unit may cause execution of calculation processing on the number based on the formula.

In the information processing apparatus, the execution control unit may generate and output a command to execute processing based on the drawing content analyzed by the drawing analysis unit.

In the information processing apparatus, the execution control unit may generate and output a prompt to execute processing based on the drawing content analyzed by the drawing analysis unit, as input text for a generative AI.

A control method for an information processing apparatus according to a second aspect of the present invention includes: a step of detecting, at a drawing detection unit, a drawing stroke corresponding to a trajectory of handwritten input in a screen region; a step of analyzing, at a drawing analysis unit, drawing content of the drawing stroke detected by the drawing detection unit; and a step of causing, at an execution control unit, execution of processing based on the drawing content analyzed by the drawing analysis unit and a positional relationship between the drawing stroke detected by the drawing detection unit and content displayed in the screen region other than the drawing stroke.

A non-transitory computer-readable medium for an information processing apparatus, comprising instructions stored thereon, that when executed on the information processing apparatus, perform steps of:

detecting, at a drawing detection unit, a drawing stroke corresponding to a trajectory of handwritten input in a screen region;

analyzing, at a drawing analysis unit, drawing content of the drawing stroke detected by the drawing detection unit; and

causing, at an execution control unit, execution of processing based on the drawing content analyzed by the drawing analysis unit and a positional relationship between the drawing stroke detected by the drawing detection unit and content displayed in the screen region other than the drawing stroke.

The above-described aspects of the present invention can more effectively utilize operations performed on a screen.

### BRIEF DESCRIPTION OF THE DRAWINGS

FIG. 1 is a diagram illustrating an example of the configuration of an information processing system according to an embodiment.

FIG. 2 is a block diagram illustrating an example of the hardware configuration of an information processing apparatus according to the embodiment.

FIG. 3 is a diagram illustrating an example of a UI for handwritten input according to the embodiment.

FIGS. 4A-4B are diagrams illustrating a first example of a handwritten input execution process according to the embodiment.

FIGS. 5A-5B are diagrams illustrating a second example of the handwritten input execution process according to the embodiment.

FIGS. 6A-6C are diagrams illustrating a third example of the handwritten input execution process according to the embodiment.

FIG. 7 is a block diagram illustrating an example of a functional configuration related to the handwritten input execution process according to the embodiment.

FIG. 8 is a flowchart illustrating an example of the handwritten input execution process according to the embodiment.

FIG. 9 is a flowchart illustrating a specific example of the handwritten input execution process according to the embodiment.

FIGS. 10A-10B are diagrams illustrating a fourth example of the handwritten input execution process according to the embodiment.

FIG. 11 is a diagram illustrating a fifth example of the handwritten input execution process according to the embodiment.

FIG. 12 is a diagram illustrating a sixth example of the handwritten input execution process according to the embodiment.

### DETAILED DESCRIPTION

An embodiment of the present invention will be described below with reference to the drawings.

### System Configuration

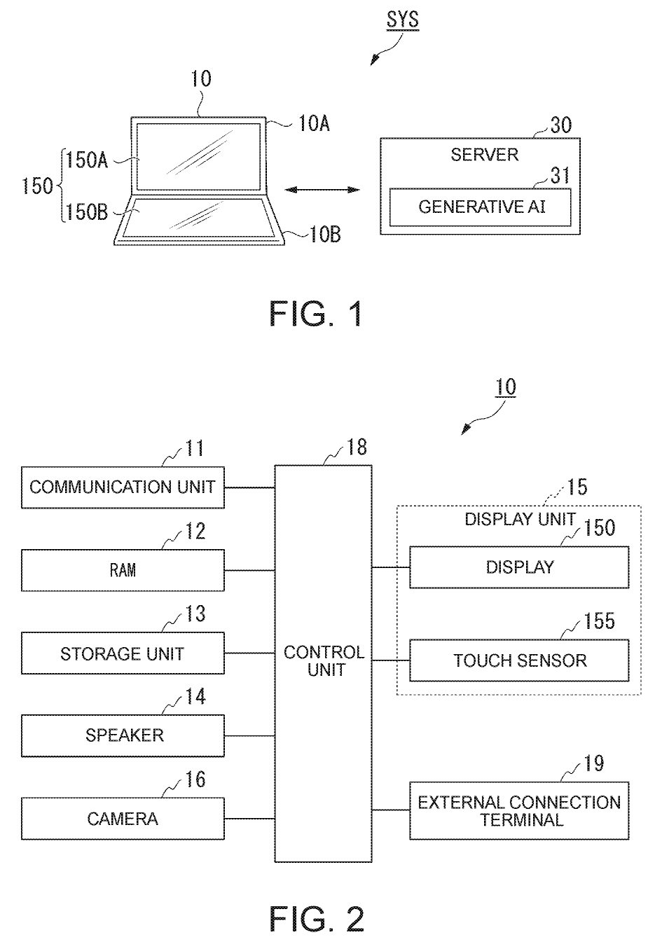

FIG. 1 is a diagram illustrating an example of the configuration of an information processing system according to this embodiment. An information processing system SYS includes an information processing apparatus 10 and a server 30.

The information processing apparatus 10 is, for example, a clamshell-type (laptop) personal computer (PC). The information processing apparatus 10 includes a first chassis 10A and a second chassis 10B that are each approximately quadrilateral plate-like (for example, flat plate-like) and are joined (connected) via a hinge mechanism so as to be openable and closable. Moreover, a display 150 extends from the first chassis 10A to the second chassis 10B in the information processing apparatus 10.

The display 150 is a flexible display capable of bending when the first chassis 10A and the second chassis 10B are opened and closed. As the flexible display, for example, an organic EL display is used. For example, the display 150 can be used not only in a single-screen mode in which the entire screen region is treated as one screen, but also in a dual-screen mode in which the screen is divided into two screens, namely, a first screen region 150A on the first chassis 10A side and a second screen region 150B on the second chassis 10B side. For example, when the information processing apparatus 10 is placed on a desk for use, the second screen region 150B on the second chassis 10B side is an approximately horizontal screen parallel to the surface of the desk.

A touch sensor is provided on the screen of the display 150 (i.e., its surface), allowing a user to perform touch operations using a finger, a stylus, or the like. The information processing apparatus 10 is capable of detecting touch operations on the screen region of the display 150. By opening the information processing apparatus 10, the user can view the display of the display 150 provided on the inner surfaces of the first chassis 10A and the second chassis 10B and perform touch operations on the display 150. The user can thus use the information processing apparatus 10.

The server 30 includes a generative AI 31. Various types of generative artificial intelligence (AI) can be applied to the generative AI 31. The generative AI 31 is, for example, a generative AI with a large language model (LLM), vision LLM, and the like. For example, based on drawing content (such as characters) handwritten by the user (i.e., input by handwriting by the user) in any part of the screen of the display 150 of the information processing apparatus 10, the generative AI 31 outputs text information (sentences) for executing, on the handwritten input part, processing based on the drawing content (such as characters) (described in detail later).

The text information may be used as a command to cause an application to execute a specific function, or as a prompt as input text for various types of generative AI. Here, "various types of generative AI” include, for example, the above-described generative AI with a large language model (LLM), and a generative AI with an image generation model trained by a diffusion model. Any generative AI can be applied depending on the intended use.

The server 30 may be configured as a single server or distributed across a plurality of servers. For example, one server 30 may include a plurality of generative AIs, or a plurality of servers 30 may be provided for respective generative AIs.

Although an example in which the server 30 includes the generative AI 31 and the information processing apparatus 10 communicates with the server 30 to utilize the functions of the generative AI 31 is described in this embodiment, alternatively the information processing apparatus 10 may download the functions of the generative AI 31 and use them locally.

### Hardware Configuration of Information Processing Apparatus 10

A specific configuration of the information processing apparatus 10 will be described below.

FIG. 2 is a block diagram illustrating an example of the hardware configuration of the information processing apparatus 10 according to this embodiment. The information processing apparatus 10 includes a communication unit 11, a random access memory (RAM) 12, a storage unit 13, a speaker 14, a display unit 15, a camera 16, and a control unit 18. These components are communicably connected via a bus or the like.

The communication unit 11 includes, for example, a plurality of Ethernet (registered trademark) ports, a plurality of Universal Serial Bus (USB) ports, or other digital input/output ports, and communication devices for performing wireless communication such as Bluetooth (registered trademark) or Wi-Fi (registered trademark).

For example, the communication unit 11 can communicate with a stylus, mouse, touchpad, or the like using Bluetooth (registered trademark). The communication unit 11 can also communicate with the server 30 illustrated in FIG. 1 by connecting to the Internet via wireless communication such as Wi-Fi (registered trademark) or wired communication such as Ethernet (registered trademark).

The RAM 12 is a volatile memory in which programs and data of processes executed by the control unit 18 are expanded and also various data are stored or erased according to need. Since the RAM 12 is a volatile memory, the RAM 12 does not retain data when power supply to the RAM 12 is stopped. Data that needs to be retained when power supply to the RAM 12 is stopped is transferred to the storage unit 13.

The storage unit 13 is a storage device that includes one or more of a solid state drive (SSD), hard disk drive (HDD), read only memory (ROM), and flash-ROM. For example, the storage unit 13 stores programs and setting data of Basic Input Output System (BIOS), an operating system (OS), programs of applications running on the OS, and various data used by the applications.

The speaker 14 outputs electronic sounds, voice, and the like.

The display unit 15 includes the display 150 and a touch sensor 155. The display 150 is a flexible display capable of bending as the first chassis 10A and the second chassis 10B are opened and closed, as mentioned above. The display 150 displays the desktop screen of the OS, windows of running applications, and the like under the control of the control unit 18.

The touch sensor 155 is provided on the screen of the display 150 and detects touch operations on the screen. Examples of the touch operations include tap operations, slide operations, flick operations, swipe operations, and pinch operations. As an operation means for performing touch operations, a finger, a stylus, etc. may be used.

The camera 16 includes a lens, an imaging device, and the like. The camera 16 captures images (still or moving images) and outputs data of the captured images under the control of the control unit 18.

The control unit 18 includes processors such as a central processing unit (CPU), a graphic processing unit (GPU), and a microcomputer, which execute programs stored in the storage unit 13 or the like (i.e., various programs such as BIOS, OS, and applications running on the OS) to achieve various functions. For example, the control unit 18 controls the screen mode of the display 150, controls display in the screen region, and detects touch operations on the touch sensor 155.

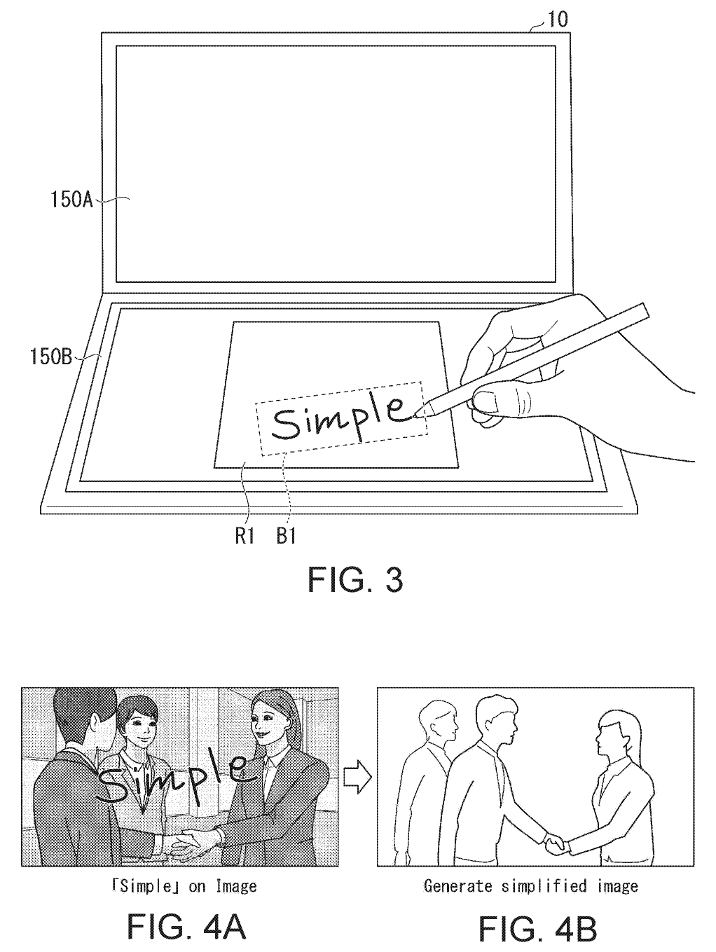

Next, a handwritten input execution process in which the information processing apparatus 10 executes processing based on drawing content (such as characters) handwritten by the user on the screen of the display 150 will be described. First, a user interface (UI) will be described with reference to FIG. 3.

FIG. 3 is a diagram illustrating an example of a UI for handwritten input according to this embodiment. In the illustrated example, the information processing apparatus 10 controls the display 150 in the dual-screen mode of the first screen region 150A and the second screen region 150B. Content such as the desktop screen of the OS and windows of running applications is displayed in the first screen region 150A and the second screen region 150B.

In the handwritten input execution process, the user performs a predetermined operation to create a transparent layer for handwritten input on the screen of the display 150, allowing handwritten input using a stylus (or finger) or the like at any location on the current screen display. Examples of the predetermined operation include simultaneously operating a plurality of predetermined keys, and launching a specific application for handwritten input.

Although the user handwrites characters using a stylus in the second screen region 150B in the example illustrated in the drawing, the user may perform input to the first screen region 150A. When the information processing apparatus 10 detects the drawing strokes corresponding to the trajectory of the handwritten input, the information processing apparatus 10 sets a bounding box B1 indicating the range of the drawing strokes and analyzes the positional relationship with other displayed content. In the illustrated example, the bounding box B1 (drawing strokes) overlaps content R1 displayed in the second screen region 150B. Therefore, the information processing apparatus 10 determines that the drawing content (such as characters) handwritten by the user relates to processing on the content R1, and executes, on the content R1, processing based on the drawing content (such as characters).

The content R1 is not particularly limited, and may be, for example, an image displayed on the screen, text (sentences) displayed on the screen, or a window of an application displayed on the screen. An image and/or text (sentence) are typically displayed within a window of some application, and the range of the content R1 is not limited to the entire window and may be only a part of a window, such as an image or text (sentence) within the window.

Examples of the handwritten input execution process will be described with reference to FIGS. 4A to 6C.

FIGS. 4A-4B are diagrams illustrating a first example of the handwritten input execution process according to this embodiment. The example illustrated in FIGS. 4A-4B is a process executed in the case where characters (drawing strokes) handwritten by the user overlap a region of an image. In this example, “Simple” is input by handwriting on the image, as illustrated in FIG. 4A. The information processing apparatus 10 analyzes the processing desired by the user based on the fact that the input characters are “Simple” and the characters (drawing strokes) overlap the region of the image, and generates a prompt instructing the generation of a simplified image of the image. The information processing apparatus 10 then inputs the prompt and the image to an image generation AI (for example, by transmission to the server 30), thereby obtaining a simplified generated image illustrated in FIG. 4B.

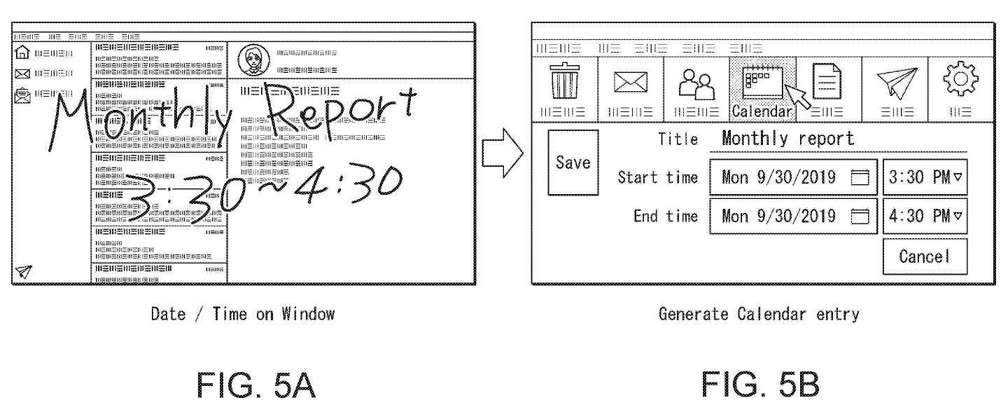

FIGS. 5A-5B are diagrams illustrating a second example of the handwritten input execution process according to this embodiment. The example illustrated in FIGS. 5A-5B is a process executed in the case where characters (drawing strokes) handwritten by the user overlap a region of a window of an application. The application has at least email and calendar functions. In this example, “Monthly Report 3:30–4:30” is input by handwriting on the window of the email screen, as illustrated in FIG. 5A. The information processing apparatus 10 analyzes that the processing desired by the user is to add a schedule, given that the input characters (drawing strokes) relate to time and item (monthly report) and overlap the region of the window of the application having email and calendar functions. The information processing apparatus 10 accordingly outputs a command to execute the calendar function to the application. As a result, a window of a calendar screen is displayed as illustrated in FIG. 5B. For example, in the case where the information processing apparatus 10 analyzes that the processing desired by the user is to add a schedule, a calendar entry is generated and displayed, adding the input time and item (monthly report) to the calendar. If only a date and time are handwritten, the registered calendar schedule for the input date and time may be displayed.

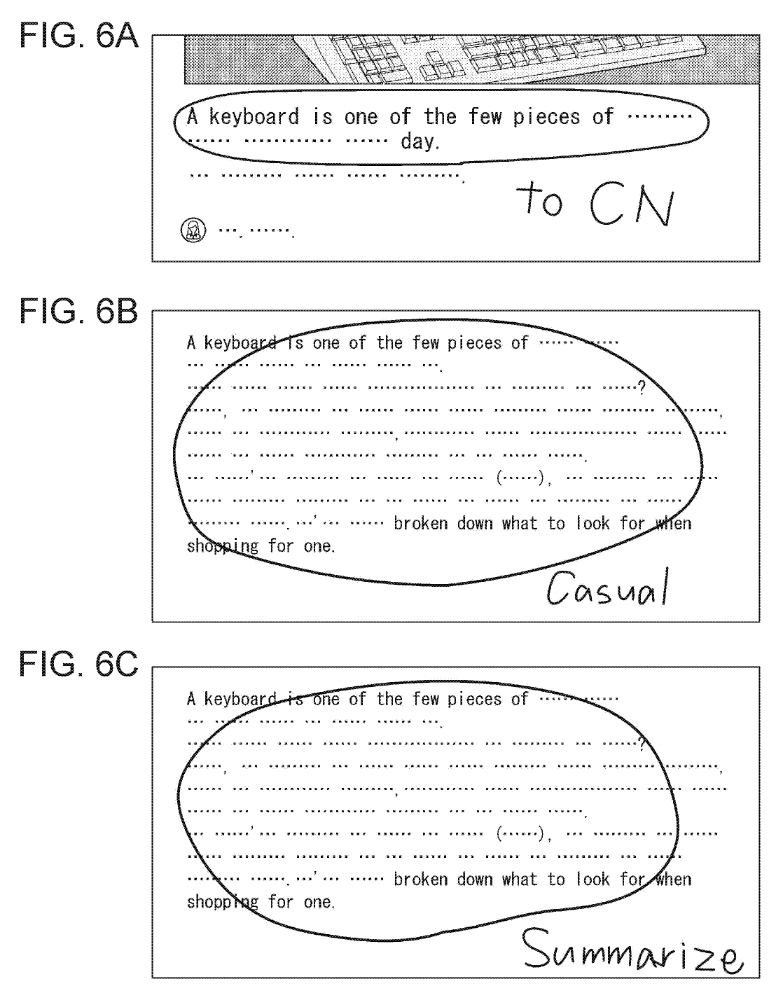

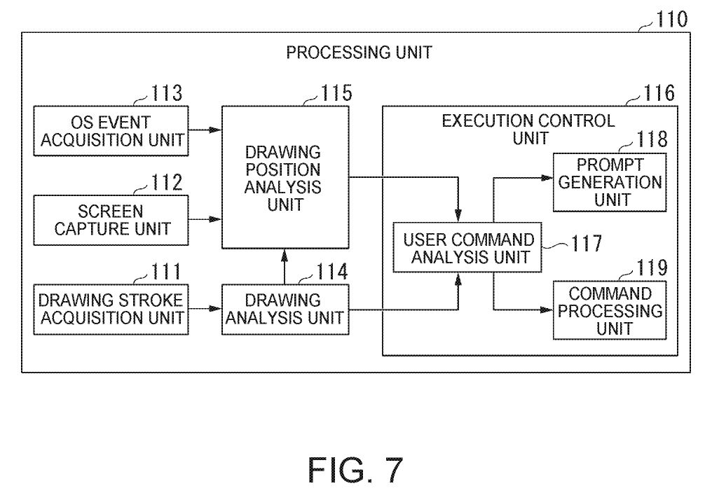

FIGS. 6A-6C are diagrams illustrating a third example of the handwritten input execution process according to this embodiment. The example illustrated in FIGS. 6A-6C is a process executed in the case where drawing strokes handwritten by the user overlap a region of a character string (sentence). As in the examples in FIGS. 4A-4B and 5A-5B, the user may handwrite characters indicating the desired processing in the region of the character string. However, in the case where the processing target is a character string, it is difficult to determine the range of the processing target.

Accordingly, in the example illustrated in FIGS. 6A-6C, the drawing strokes handwritten by the user include a drawing stroke indicating the range of the processing target and drawing strokes of characters indicating the processing content. In the examples illustrated in FIGS. 6A-6C, the user selects the range of the character string as the processing target by circling it with handwriting. The range of the character string as the processing target is selected by roughly circling the range, thereby selecting a block of character string.

The user also handwrites the processing content beside (adjacent to) the range selected by handwriting. In the example illustrated in FIG. 6A, “to CN” is handwritten as the processing content, indicating translation into Chinese. In the example illustrated in FIG. 6B, “Casual” is handwritten as the processing content, indicating conversion into a casual expression. In the example illustrated in FIG. 6C, “Summarize” is handwritten as the processing content, indicating generation of a summary.

In the case where the drawing strokes handwritten by the user overlap a region of a character string, the information processing apparatus 10 causes execution of processing on the character string. For example, in the case where the drawing stroke indicating the range of the processing target overlaps a region of a character string, the information processing apparatus 10 causes execution of processing based on the drawing strokes of the characters indicating the processing content, on the character string overlapping the drawing stroke indicating the range.

Specifically, in the example illustrated in FIG. 6A, the information processing apparatus 10 causes execution of processing to translate the character string selected as the processing target into Chinese. For example, the information processing apparatus 10 executes a command to launch an application having translation functions, and inputs the character string selected as the processing target to the launched application as the translation target, thereby obtaining the translation result.

In the example illustrated in FIG. 6B, the information processing apparatus 10 causes execution of processing to convert the character string selected as the processing target into a casual expression. For example, the information processing apparatus 10 generates a prompt indicating an instruction to convert the selected character string into a casual expression, and inputs the generated prompt to the generative AI 31, thereby obtaining the character string converted into a casual expression generated by the generative AI 31.

In the example illustrated in FIG. 6C, the information processing apparatus 10 causes execution of processing to generate a summary of the character string selected as the processing target. For example, the information processing apparatus 10 generates a prompt indicating an instruction to generate a summary of the selected character string, and inputs the generated prompt to the generative AI 31, thereby obtaining a summary generated by the generative AI 31.

In the example illustrated in FIGS. 6A-6C, although examples in which the user circles the range of the character string to be processed by handwriting, if the range of the character string is clear without circling, the characters indicating the processing content may be handwritten to overlap the character string in order to execute processing.

### Functional Configuration of Handwritten input Execution Process

Next, the handwritten input execution process of executing processing based on drawing content (such as characters) handwritten by the user on the screen will be described in detail.

FIG. 7 is a block diagram illustrating an example of a functional configuration related to the handwritten input execution process according to this embodiment. A processing unit 110 in the drawing has a functional configuration for performing the handwritten input execution process by the control unit 18 executing an application program. The functions of the components included in the processing unit 110 may be implemented by a single application or by a plurality of applications.

The processing unit 110 includes a drawing stroke acquisition unit 111, a screen capture unit 112, an OS event acquisition unit 113, a drawing analysis unit 114, a drawing position analysis unit 115, and an execution control unit 116.

The drawing stroke acquisition unit 111 (an example of a drawing detection unit) detects one or more drawing strokes handwritten in the screen region of the display 150. The drawing stroke acquisition unit 111 also sets and acquires a bounding box (for example, the bounding box B1 illustrated in FIG. 2) indicating the range of the drawing strokes handwritten in the screen region of the display 150. Examples of the drawing strokes include the character-indicating drawing strokes illustrated in FIGS. 4A to 6C and the range-indicating drawing strokes illustrated in FIGS. 6A-6C.

The screen capture unit 112 captures the screen region of the display 150 as one item of information for analyzing the positional relationship between the handwritten drawing strokes and content displayed on the screen. For example, in the case where the drawing stroke acquisition unit 111 detects the drawing strokes, the screen capture unit 112 captures a screen region including the range (bounding box) of the detected drawing strokes and stores the captured image. By analyzing the captured image of the screen region, for example, information on whether the content displayed in the screen region is an image or a character string is obtained.

The OS event acquisition unit 113 acquires an OS event log as one item of information for analyzing the positional relationship between the handwritten drawing strokes and content displayed on the screen. By analyzing the OS event log, for example, information on windows displayed in the screen region and which window is the active window is obtained.

The drawing analysis unit 114 analyzes the drawing content of the drawing strokes detected by the drawing stroke acquisition unit 111. For example, the drawing analysis unit 114 analyzes the shape of the drawing strokes to detect, as the drawing content, characters or lines indicating a range (enclosing lines), etc. In the case where characters are detected, the drawing analysis unit 114 detects a grouping of characters composed of one or more words among the characters.

The drawing position analysis unit 115 analyzes the positional relationship between the drawing strokes detected by the drawing stroke acquisition unit 111 and content displayed in the screen region of the display 150 other than the drawing strokes. For example, the drawing position analysis unit 115 analyzes the positional relationship between the bounding box of the drawing strokes and content displayed in the screen region based on the captured image of the screen obtained by the screen capture unit 112 or the OS event log obtained by the OS event acquisition unit 113.

As an example, the drawing position analysis unit 115 performs screen analysis to determine which content the user has handwritten on, based on the bounding box of the drawing strokes and the captured image of the screen. As another example, the drawing position analysis unit 115 performs OS UI configuration analysis to determine which content the user has handwritten on, based on the bounding box of the drawing strokes and the OS event log.

The execution control unit 116 causes execution of processing based on the analysis results of the drawing position analysis unit 115 (the positional relationship between the drawing strokes and the content) and the drawing content analyzed by the drawing analysis unit 114. For example, the execution control unit 116 causes execution of processing based on the drawing content analyzed by the drawing analysis unit 114, on the content that is displayed in the screen region and overlaps the drawing strokes (bounding box).

Specifically, in the case where the drawing strokes overlap a region of an image displayed in the screen region, the execution control unit 116 may cause execution of image processing based on the drawing content analyzed by the drawing analysis unit 114, on the image (see FIGS. 4A-4B).

In the case where the drawing strokes overlap a region of a window of an application displayed in the screen region, the execution control unit 116 may cause execution of processing of the function corresponding to the drawing content analyzed by the drawing analysis unit 114 among the functions of the application (see FIGS. 5A-5B).

In the case where the drawing strokes overlap a region of a character string displayed in the screen region, the execution control unit 116 may cause execution of processing based on the drawing content analyzed by the drawing analysis unit 114, on the character string (see FIGS. 6A-6C). Here, if drawing strokes indicating characters and drawing strokes indicating a range are extracted by the drawing analysis unit 114, the execution control unit 116 may cause execution of processing based on the character-indicating drawing strokes, on the content that is displayed in the screen region and overlaps the range-indicating drawing strokes (see FIGS. 6A-6C).

The execution control unit 116 includes a user command analysis unit 117, a prompt generation unit 118, and a command processing unit 119.

The user command analysis unit 117 analyzes whether the processing based on the instruction (user command) handwritten by the user (i.e., input by handwriting by the user) requires generative AI. For example, a command list may be preset that associates commands for causing an application to directly execute processing with characters (such as words) that a user who wants to execute the processing is expected to input by handwriting, and the user command analysis unit 117 may refer to the command list to determine whether the processing requires the generative AI.

For example, if the instruction (drawing content of drawing strokes) handwritten by the user is in the command list, the user command analysis unit 117 determines that the processing does not require the generative AI. If the instruction (drawing content of drawing strokes) handwritten by the user is not in the command list, the user command analysis unit 117 determines that the processing requires the generative AI.

The prompt generation unit 118 generates, for processing determined by the user command analysis unit 117 to require the generative AI, a prompt to be input to the generative AI, based on the analysis results of the drawing position analysis unit 115 (the positional relationship between the drawing strokes and the content) and the drawing content analyzed by the drawing analysis unit 114. For example, when causing execution of processing to generate a simplified image as illustrated in FIGS. 4A-4B, the prompt generation unit 118 generates a prompt to be input to the generative AI. Similarly, when causing execution of processing to convert a character string (sentence) into a casual expression as illustrated in FIG. 6B or to generate a summary of a character string (sentence) as illustrated in FIG. 6C, the prompt generation unit 118 generates a prompt to be input to the generative AI.

The prompt generation unit 118 may generate prompts using generative AI such as an LLM or vision LLM, or using templates. For example, keywords (expected words) related to processing indicated by handwritten input operation by the user and templates for prompts using the keywords may be preset, and the prompt generation unit 118 may generate each prompt using the corresponding template.

The command processing unit 119 generates, for processing determined by the user command analysis unit 117 not to require the generative AI, a command for causing the application to directly execute the processing, based on the analysis results of the drawing position analysis unit 115 (the positional relationship between the drawing strokes and the content) and the drawing content analyzed by the drawing analysis unit 114. For example, when causing execution of processing to generate a calendar entry of an application as illustrated in FIGS. 5A-5B, the command processing unit 119 generates a command using an application programming interface (API) of the application. Similarly, when causing execution of processing to translate a character string (sentence) into Chinese as illustrated in FIG. 6A, the command processing unit 119 generates a command to launch an application having translation functions.

### Operation of Handwritten Input Execution Process

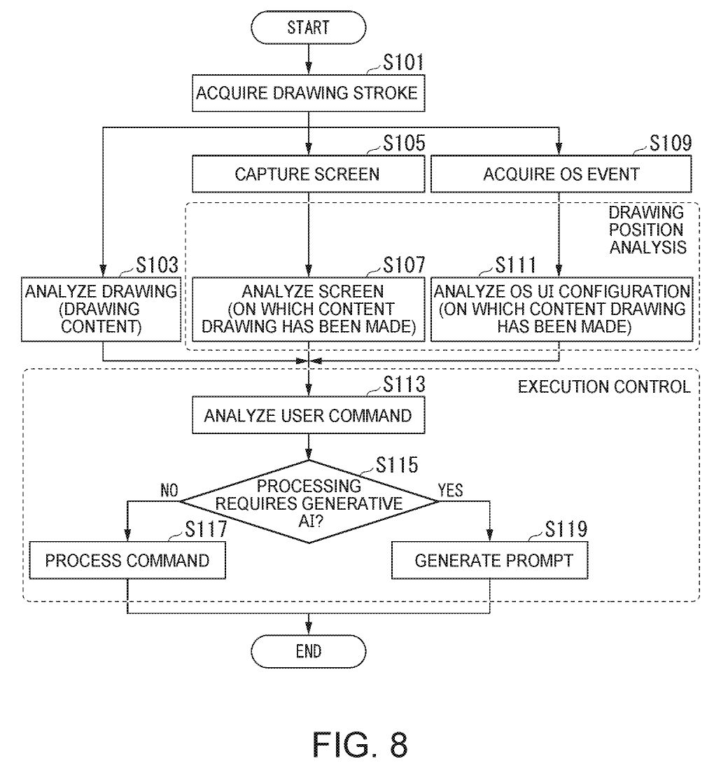

Next, the operation of the handwritten input execution process performed by the processing unit 110 will be described. FIG. 8 is a flowchart illustrating an example of the handwritten input execution process according to this embodiment.

(Step S101) The processing unit 110 detects one or more drawing strokes handwritten in the screen region of the display 150, and acquires a bounding box indicating the range of the drawing strokes. The processing unit 110 then proceeds to steps S103, S105, and S109.

(Step S103) The processing unit 110 analyzes the drawing content of the drawing strokes detected in step S101. For example, the processing unit 110 analyzes the shapes of the drawing strokes to detect characters or lines indicating a range (circling lines) as the drawing content. In the case where characters are detected, the processing unit 110 detects a grouping of characters composed of one or more words among the characters. The processing unit 110 then proceeds to step S113.

(Step S105) The processing unit 110 captures the screen region of the display 150, and stores the captured image. Here, the processing unit 110 captures the screen region excluding the layer of handwritten input. The processing unit 110 may capture the entire screen region of the display 150 or, based on the bounding box acquired in step S101, capture at least part of the screen region including the bounding box. The processing unit 110 then proceeds to step S107.

(Step S107) The processing unit 110 performs screen analysis regarding the positional relationship between the drawing strokes and content displayed in the screen region, based on the bounding box of the drawing strokes detected in step S101 and the captured image of the screen captured in step S105. For example, the processing unit 110 performs screen analysis regarding which content the user has handwritten on. The processing unit 110 then proceeds to step S113.

(Step S109) The processing unit 110 acquires an OS event log. The processing unit 110 then proceeds to step S111.

(Step S111) The processing unit 110 performs OS UI configuration analysis regarding the positional relationship between the drawing strokes and content displayed in the screen region based on the bounding box of the drawing strokes detected in step S101 and the OS event log acquired in step S109. For example, the processing unit 110 performs OS UI configuration analysis regarding which content the user has handwritten on. The processing unit 110 then proceeds to step S113.

(Step S113) The processing unit 110 analyzes the processing based on the drawing content of the drawing strokes analyzed in step S103 and the analysis results (the positional relationship between the drawing strokes and content) in step S107 or S111, i.e., the instruction (user command) handwritten by the user. The processing unit 110 then proceeds to step S115.

(Step S115) The processing unit 110 determines whether the processing (user command) analyzed in step S113 requires generative AI. For example, the processing unit 110 refers to the preset command list as mentioned above. If the processing can be achieved by a command for causing the application to directly execute the processing, the processing unit 110 determines that the processing does not require the generative AI. Otherwise, the processing unit 110 determines that the processing requires the generative AI. In the case where the processing unit 110 determines that the processing does not require the generative AI (NO), the processing unit 110 proceeds to step S117. In the case where the processing unit 110 determines that the processing requires the generative AI (YES), the processing unit 110 proceeds to step S119.

(Step S117) The processing unit 110 generates and outputs a command for causing the application to directly execute the processing, in order to cause execution of the processing based on the drawing content of the drawing strokes analyzed in step S103 and the analysis results (the positional relationship between the drawing strokes and content) in step S107 or S111.

(Step S119) The processing unit 110 generates and outputs a prompt to be input to the generative AI, in order to cause execution of the processing based on the drawing content of the drawing strokes analyzed in step S103 and the analysis results (the positional relationship between the drawing strokes and content) in step S107 or S111.

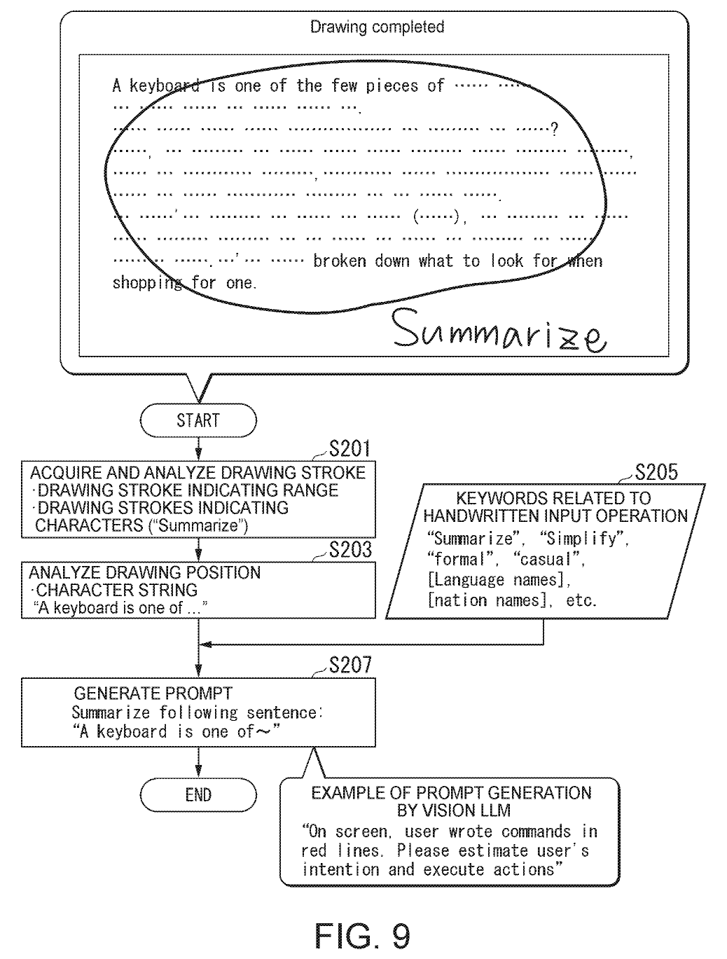

Next, a specific example of the operation of generating a prompt by the handwritten input execution process will be described with reference to FIG. 9. FIG. 9 is a flowchart illustrating a specific example of the handwritten input execution process according to this embodiment. Here, the case of generating a summary of a character string (sentence) as illustrated in FIG. 6C is used as an example. When the drawing of the drawing stroke indicating the range of the processing target and the drawing strokes of characters indicating the processing content is completed by handwritten input by the user, the process is started.

(Step S201) The processing unit 110 detects one or more drawing strokes handwritten in the screen region of the display 150, and acquires a bounding box indicating the range of the drawing strokes. The processing unit 110 then analyzes the drawing content of the detected drawing strokes. Here, the drawing stroke indicating the range of the processing target (circling line) and the drawing strokes of characters (“Summarize”) indicating the processing content are detected. The process in step S201 is a specific example of the processes in steps S101 and S103 illustrated in FIG. 8. The processing unit 110 then proceeds to step S203.

(Step S203) The processing unit 110 analyzes the position of the drawing strokes (the positional relationship with content displayed in the screen region) based on the captured image of the screen and the OS event log. Here, the drawing stroke indicating the range of the processing target (circling line) overlaps the region of the character string (“A keyboard is one of ...”) displayed on the screen. The process in step S203 is a specific example of the processes in steps S107 and S111 illustrated in FIG. 8. The processing unit 110 then proceeds to step S205.

(Step S205) The processing unit 110 acquires a list of keywords (expected words) related to processing indicated by handwritten input operation by the user. The processing unit 110 then proceeds to step S207.

(Step S207) The processing unit 110 determines that the processing cannot be executed by a command for causing an application to directly execute the processing but requires the generative AI, and generates and outputs a prompt to be input to the generative AI. For example, since the word of the drawing strokes of characters (“Summarize”) detected in step S201 is included in the keywords acquired in step S205, the processing unit 110 may generate a prompt using a template.

An example of generating a prompt using a template is as follows:

“Summarize following sentence: ‘A keyboard is one of ...’”

In this example, the generative AI is instructed to generate a summary of the target character string (sentence).

The processing unit 110 may generate a prompt using generative AI such as vision LLM.

An example of generating a prompt using generative AI is as follows:

“On screen, user wrote commands in red lines. Please estimate user’s intention and execute actions”

In this example, the generative AI is instructed to execute processing based on assumption from the drawing strokes, without explicitly specifying the processing content.

### Other Examples of Handwritten Input Execution Process

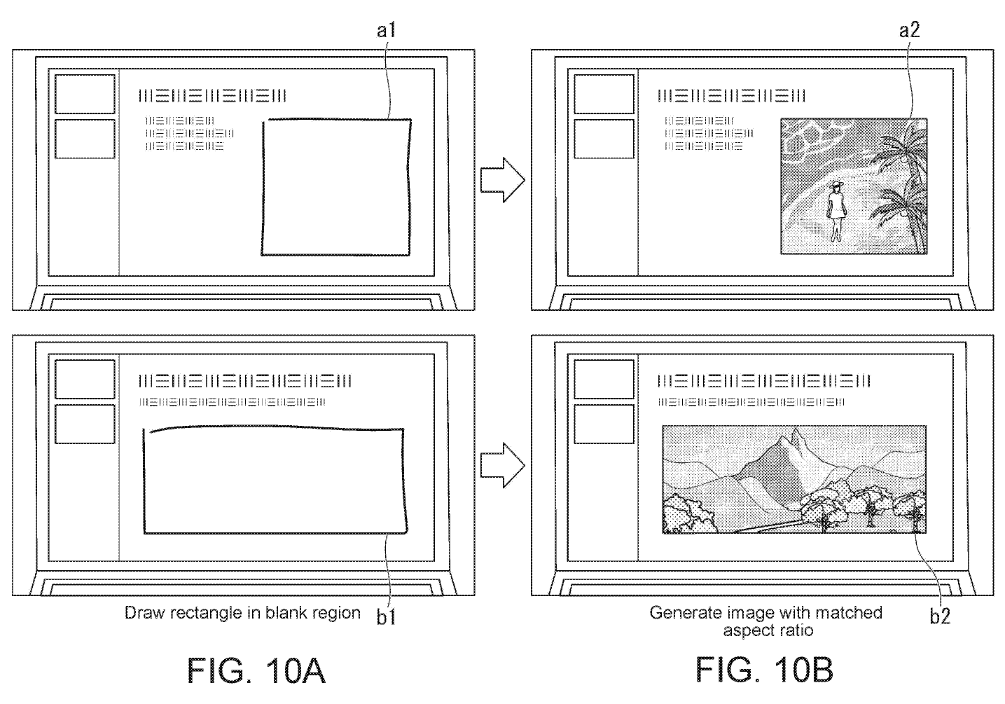

Next, other examples of the handwritten input execution process will be described with reference to FIGS. 10A to 12.

FIGS. 10A-10B are diagrams illustrating a fourth example of the handwritten input execution process according to this embodiment. The example illustrated in FIGS. 10A-10B is a process executed in the case where a drawing stroke handwritten by the user overlaps a blank region within the screen region. The blank region may be a blank portion within an application window. In the case where the information processing apparatus 10 detects a drawing stroke on a blank region, the information processing apparatus 10 causes execution of predetermined processing.

In the illustrated example, in the case where a rectangular drawing stroke (a1, b1) is detected in a blank region as illustrated in FIG. 10A, the information processing apparatus 10 causes execution of processing to generate an image (a2, b2) corresponding to the aspect ratio of the rectangle (i.e., image with the matched aspect ratio of the rectangle) as illustrated in FIG. 10B.

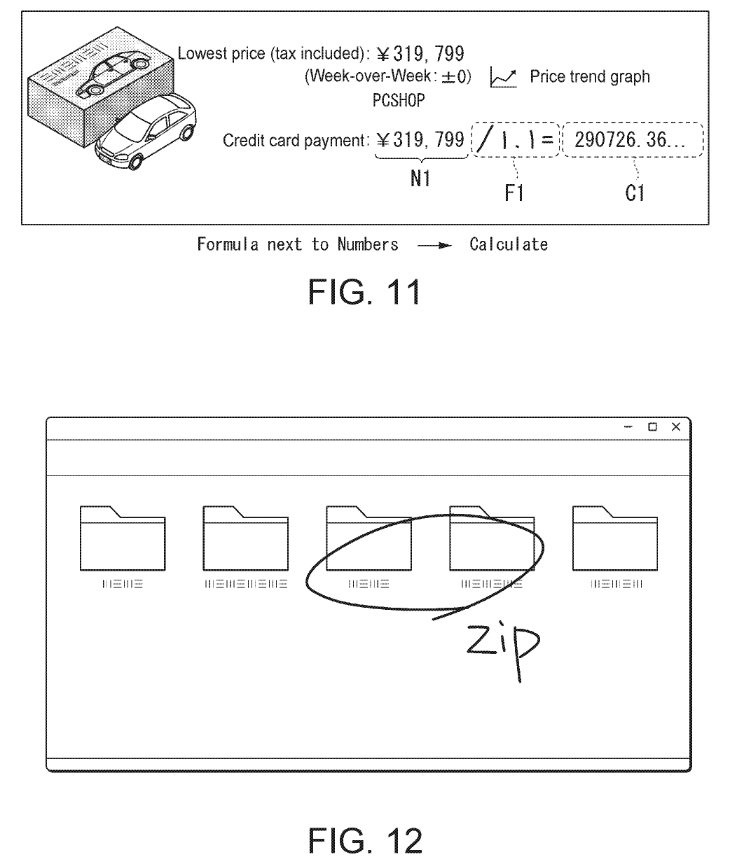

FIG. 11 is a diagram illustrating a fifth example of the handwritten input execution process according to this embodiment. The example illustrated in FIG. 11 is a process in which content that is displayed in the screen region and is adjacent to drawing strokes handwritten by the user is the processing target. For example, in the case where the drawing strokes handwritten by the user include a formula (F1) and are adjacent to a region of a number (N1) displayed in the screen region, the information processing apparatus 10 causes execution of, on the number (N1), calculation processing based on the formula (F1) handwritten by the user, and display of the calculation result (C1).

FIG. 12 is a diagram illustrating a sixth example of the handwritten input execution process according to this embodiment. The example illustrated in FIG. 12 is a process executed in the case where a range-indicating drawing stroke handwritten by the user overlaps a folder region displayed in the screen region. In the case where the range-indicating drawing stroke overlaps a folder region, the information processing apparatus 10 treats the overlapping folders as selected. Upon detecting drawing strokes of characters (“zip”) indicating processing content beside the range-indicating drawing stroke, the information processing apparatus 10 causes execution of processing to compress the selected folders in ZIP format. This is not limited to the selection of folders, and may also be applied to the selection of files. Furthermore, the processing is not limited to compression in ZIP format.

As described above, the information processing apparatus 10 according to this embodiment detects a drawing stroke corresponding to a trajectory of handwritten input in a screen region of the display 150, and analyzes drawing content of the detected drawing stroke. The information processing apparatus 10 then causes execution of processing based on the drawing content of the detected drawing stroke and a positional relationship between the detected drawing stroke and content displayed in the screen region other than the drawing stroke.

In this way, the information processing apparatus 10 allows the user to simply input by handwriting the desired processing content on the screen using a stylus or the like, and the input processing is performed on the content displayed in that part. This can be applied not only to search functions but also to various other functions, providing convenience to the user. Thus, the information processing apparatus 10 can more effectively utilize operations performed on the screen.

For example, the information processing apparatus 10 causes execution of processing based on the drawing content of the detected drawing stroke, on content that is displayed in the screen region and overlaps the detected drawing stroke.

In this way, the information processing apparatus 10 allows the user to simply input by handwriting the desired processing content on content displayed in the screen region using a stylus or the like, and the input processing is performed on the content. This provides convenience to the user.

For example, in the case where the detected drawing stroke overlaps a region of a window of an application displayed in the screen region, the information processing apparatus 10 causes execution of processing of a function corresponding to the drawing content, among functions of the application.

In this way, the information processing apparatus 10 allows the user to simply input by handwriting the desired processing content on a window of an application displayed in the screen region using a stylus or the like, and the input processing is performed on the application. This provides convenience to the user. For example, as illustrated in FIGS. 5A-5B, when the user simply inputs by handwriting the time and item of a schedule to be registered over a region of a window of an application having email and calendar functions in the screen region, the calendar registration screen is opened and the schedule can be registered, providing convenience to the user.

For example, in the case where the detected drawing stroke overlaps a region of an image displayed in the screen region, the information processing apparatus 10 causes execution of image processing based on the drawing content, on the image.

In this way, the information processing apparatus 10 allows the user to simply input by handwriting the desired processing content on an image displayed in the screen region using a stylus or the like, and the input processing is performed on the image. This provides convenience to the user. For example, as illustrated in FIGS. 4A-4B, when the user simply inputs by handwriting “Simple” over a region of an image in the screen region, a simplified image is generated, providing convenience to the user.

For example, in the case where the detected drawing stroke overlaps a region of a character string displayed in the screen region, the information processing apparatus 10 causes execution of the processing based on the drawing content, on the character string.

In this way, the information processing apparatus 10 allows the user to simply input by handwriting the desired processing content on a character string displayed in the screen region using a stylus or the like, and the input processing is performed on the character string. This provides convenience to the user.

The information processing apparatus 10 analyzes the detected drawing stroke to extract, as the drawing content, a drawing stroke indicating a character and a drawing stroke indicating a range. The information processing apparatus 10 then causes execution of processing based on the drawing stroke indicating the character, on content that is displayed in the screen region and overlaps the drawing stroke indicating the range.

In this way, when the user wants to process a character string displayed in the screen region, the information processing apparatus 10 allows the user to simply input by handwriting the range of the character string as the processing target and the desired processing content using a stylus or the like, and the input processing is performed on the character string. This provides convenience to the user. For example, as illustrated in FIGS. 6A-6C, when the user simply circles the range of the character string as the processing target by handwriting and handwrites the desired processing content such as “to CN,” “Casual,” or “Summarize” beside it, translation into Chinese, conversion into a casual expression, or generation of a summary can be performed, providing convenience to the user.

The desired processing content (e.g., “to CN,” “Casual,” “Summarize”) may be input by voice instead of handwriting. For example, the information processing apparatus 10 may include a voice input unit such as a microphone (not illustrated), and when extracting a range-indicating drawing stroke, receive voice input indicating the processing to be performed on content overlapping the range-indicating drawing stroke. In this way, when the user wants to process a character string displayed in the screen region, the information processing apparatus 10 allows the user to simply input by handwriting the range of the character string as the processing target using a stylus or the like and then input by voice the desired processing content, and the processing input by voice is performed on the character string. This provides convenience to the user. For instance, if a range-indicating drawing stroke overlaps a folder region as in the example illustrated in FIG. 12, the information processing apparatus 10 may treat the overlapping folders as selected, and when the processing content is input by voice (“zip”), execute processing to compress the selected folders in ZIP format.

In the case where the detected drawing stroke overlaps a blank region in the screen region, the information processing apparatus 10 may cause execution of preset processing.

In this way, the information processing apparatus 10 allows the user to simply perform input by handwriting on a blank region in the screen region using a stylus or the like, and preset processing is performed. This provides convenience to the user. For example, as illustrated in FIGS. 10A-10B, when the user simply handwrites a rectangle in a blank region in the screen region, an image corresponding to the aspect ratio of the rectangle is generated, which is convenient for the user.

The information processing apparatus 10 may cause execution of processing based on the drawing content, on content that is displayed in the screen region and is adjacent to the detected drawing stroke.

In this way, the information processing apparatus 10 allows the user to handwrite the desired processing content not only over content displayed in the screen region but also beside the content using a stylus or the like, enabling flexible response according to the display state of the screen. This provides high versatility and convenience to the user.

In the case where the detected drawing stroke includes a formula and is adjacent to a region of a number displayed in the screen region, the information processing apparatus 10 may cause execution of calculation processing based on the formula, on the number.

In this way, the information processing apparatus 10 allows the user to simply handwrite a formula beside a number displayed in the screen region, and the calculation results are displayed, providing convenience to the user. For example, when the price of a product is displayed excluding tax and the user wants to check the price including tax, when the price is displayed including tax and the user wants to check the price excluding tax, or when the price is displayed before a discount and the user wants to check the price after the discount, the user can obtain the calculation results simply by handwriting the formula beside the price, without using a calculator. This provides convenience to the user.

The information processing apparatus 10 generates and outputs a command to execute processing based on the drawing content.

In this way, in the case where processing does not require generative AI, the information processing apparatus 10 can promptly generate and output a command to directly execute the processing.

The information processing apparatus 10 generates and outputs a prompt to execute processing based on the drawing content, as input text for a generative AI.

In this way, in the case where processing requires the generative AI, the information processing apparatus 10 can automatically generate a prompt to be input to the generative AI based on the handwritten input.

A control method in the information processing apparatus 10 according to this embodiment includes: a step in which the processing unit 110 detects a drawing stroke corresponding to a trajectory of handwritten input in a screen region; a step in which the processing unit 110 analyzes drawing content of the detected drawing stroke; and a step in which the processing unit 110 causes execution of processing based on the analyzed drawing content and a positional relationship between the detected drawing stroke and content displayed in the screen region other than the drawing stroke.

In this way, the control method in the information processing apparatus 10 allows the user to simply input by handwriting the desired processing content on the screen using a stylus or the like, and the input processing is performed on the content displayed in that part. This can be applied not only to search functions but also to various other functions, providing convenience to the user. Thus, the control method in the information processing apparatus 10 can more effectively utilize operations performed on the screen.

While the embodiment of the present invention has been described in detail above with reference to the drawings, the specific structures are not limited to the above embodiment, and designs and the like without departing from the scope of the present invention are also included. For example, the structures described in the above embodiment may be freely combined.

Although the above embodiment describes an example in which the display 150 is a single display extending over the first chassis 10A and the second chassis 10B, the present invention is not limited to such. For example, the information processing apparatus 10 may include two displays, one on the first chassis 10A and one on the second chassis 10B. Alternatively, the information processing apparatus 10 may include a display on only one of the first chassis 10A and the second chassis 10B (for example, only the first chassis 10A).

The information processing apparatus 10 is not limited to a clamshell-type (laptop) PC, and may be, for example, a tablet PC or a desktop PC.

Although the above embodiment describes an example of a touch panel display in which an input unit (touch sensor) and display unit (display) are integrated, a non-touch panel display without an input unit (touch sensor) may alternatively be used. In this case, an input device that receives operations in place of the input unit (touch sensor) may be, for example, a touchpad, mouse, or the like.

The above-described information processing apparatus 10 includes a computer system. Processes in the components in the above-described information processing apparatus 10 may be performed by recording a program for implementing the functions of the components in the above-described information processing apparatus 10 on a computer-readable recording medium and causing a computer system to read and execute the program recorded on the recording medium. Herein, the expression “causing a computer system to read and execute the program recorded on the recording medium” includes installing the program in the computer system. The term “computer system” herein includes an OS and hardware such as peripherals. The “computer system” may include a plurality of computer devices connected via a network such as the Internet, a WAN, a LAN, or a communication line such as a dedicated line. The “computer-readable recording medium” refers to a portable medium such as a flexible disk, a magneto-optical disc, a ROM, or a CD-ROM, or a storage device such as a hard disk included in the computer system. Thus, the recording medium storing the program may be a non-transitory recording medium such as a CD-ROM.

The recording medium includes a recording medium internally or externally provided so as to be accessible from a distribution server for distributing the program. A configuration in which the program is divided into a plurality of parts and the components in the information processing apparatus 10 combine the parts after the parts are downloaded at different timings may be adopted, and distribution servers for distributing the parts into which the program is divided may be different. The “computer-readable recording medium” includes a medium that holds the program for a certain period of time, such as a volatile memory (RAM) inside a computer system serving as a server or a client when the program is transmitted via a network. The program may be a program for implementing part of the above-described functions. The program may be a differential file (differential program) that can implement the above-described functions in combination with a program already recorded in the computer system.

Some or all of the functions included in the information processing apparatus 10 according to the above embodiment may be implemented as an integrated circuit such as large scale integration (LSI). The above-described functions may be individually formed as a processor, or some or all thereof may be integrated into a processor. The method of forming an integrated circuit is not limited to LSI, and may be implemented by a dedicated circuit or a general-purpose processor. If integrated circuit technology that can replace LSI emerges as a result of the advancement of semiconductor technology, an integrated circuit based on such technology may be used.

### DESCRIPTION OF SYMBOLS

10 information processing apparatus

10A first chassis

10B second chassis

30 server

31 generative AI

11 communication unit

12 RAM

13 storage unit

14 speaker

15 display unit

16 camera

150 display

150A first screen region

150B second screen region

155 touch sensor

18 control unit

110 processing unit

111 drawing stroke acquisition unit

112 screen capture unit

113 OS event acquisition unit

114 drawing analysis unit

115 drawing position analysis unit

116 execution control unit

117 user command analysis unit

118 prompt generation unit

119 command processing unit

SYS information processing system

What is claimed is:

1. An information processing apparatus comprising:
a drawing detection unit configured to detect a drawing stroke corresponding to a trajectory of handwritten input in a screen region;
a drawing analysis unit configured to analyze drawing content of the drawing stroke detected by the drawing detection unit; and
an execution control unit configured to cause execution of processing based on the drawing content analyzed by the drawing analysis unit and a positional relationship between the drawing stroke detected by the drawing detection unit and content displayed in the screen region other than the drawing stroke.

2. The information processing apparatus according to claim 1, wherein the execution control unit is configured to cause execution of processing based on the drawing content analyzed by the drawing analysis unit, on content that is displayed in the screen region and overlaps the drawing stroke detected by the drawing detection unit.

3. The information processing apparatus according to claim 2, wherein in a case where the drawing stroke detected by the drawing detection unit overlaps a region of a character string displayed in the screen region, the execution control unit causes execution of the processing based on the drawing content analyzed by the drawing analysis unit, on the character string.

4. The information processing apparatus according to claim 2, wherein in a case where the drawing stroke detected by the drawing detection unit overlaps a region of a window of an application displayed in the screen region, the execution control unit causes execution of processing of a function corresponding to the drawing content analyzed by the drawing analysis unit, among functions of the application.

5. The information processing apparatus according to claim 2, wherein in a case where the drawing stroke detected by the drawing detection unit overlaps a region of an image displayed in the screen region, the execution control unit causes execution of image processing based on the drawing content analyzed by the drawing analysis unit, on the image.

6. The information processing apparatus according to claim 2, wherein the drawing analysis unit is configured to analyze the drawing stroke detected by the drawing detection unit and extract, as the drawing content, a drawing stroke indicating a character and a drawing stroke indicating a range, and
wherein the execution control unit causes execution of processing based on the drawing stroke indicating the character, on content that is displayed in the screen region and overlaps the drawing stroke indicating the range.

7. The information processing apparatus according to claim 1, wherein in a case where the drawing stroke detected by the drawing detection unit overlaps a blank region in the screen region, the execution control unit causes execution of preset processing.

8. The information processing apparatus according to claim 1, wherein the execution control unit is further configured to cause execution of processing based on the drawing content analyzed by the drawing analysis unit, on content that is displayed in the screen region and is adjacent to the drawing stroke detected by the drawing detection unit.

9. The information processing apparatus according to claim 8, wherein in a case where the drawing stroke detected by the drawing detection unit includes a formula and is adjacent to a region of a number displayed in the screen region, the execution control unit causes execution of calculation processing on the number based on the formula.

10. The information processing apparatus according to claim 1, wherein the execution control unit is further configured to generate and output a command to execute processing based on the drawing content analyzed by the drawing analysis unit.

11. The information processing apparatus according to claim 1, wherein the execution control unit is configured to generate and output a prompt to execute processing based on the drawing content analyzed by the drawing analysis unit, as input text for a generative AI.

12. A control method for an information processing apparatus, the control method comprising:
a step of detecting, at a drawing detection unit, a drawing stroke corresponding to a trajectory of handwritten input in a screen region;
a step of analyzing, at a drawing analysis unit, drawing content of the drawing stroke detected by the drawing detection unit; and
a step of causing, at an execution control unit, execution of processing based on the drawing content analyzed by the drawing analysis unit and a positional relationship between the drawing stroke detected by the drawing detection unit and content displayed in the screen region other than the drawing stroke.

13. A non-transitory computer-readable medium for an information processing apparatus, comprising instructions stored thereon, that when executed on the information processing apparatus, perform steps of:
detecting, at a drawing detection unit, a drawing stroke corresponding to a trajectory of handwritten input in a screen region;
analyzing, at a drawing analysis unit, drawing content of the drawing stroke detected by the drawing detection unit; and
causing, at an execution control unit, execution of processing based on the drawing content analyzed by the drawing analysis unit and a positional relationship between the drawing stroke detected by the drawing detection unit and content displayed in the screen region other than the drawing stroke.
